(19) United States
(12) Patent Application Publication
(10) Pub. No.: US 2008/0053510 A1
(43) Pub. Date: Mar. 6, 2008

(54) Solar Energy Charging Device

(76) Inventors: Kuo-Len Lin, Wugu Township (TW); Tien-Chih Tseng, Wugu Township (TW); Hai-Rui Yeh, Wugu Township (TW); Wen-Jung Liu, Wugu Township (TW)

Correspondence Address: HDSL, 4331 STEVENS BATTLE LANE, FAIRFAX, VA, 22033, US

(21) Appl. No.: 11/470,261

(22) Filed: Sep. 6, 2006

(51) Int. Cl. H02N 6/00

(52) U.S. Cl. 136/243; 136/245; 136/291

(57) ABSTRACT

A solar energy charging device includes a main body having a plurality of grooves disposed at a top surface thereof for inserting batteries or electronic devices; a plurality of indicator lights disposed at a peripheral portion of the top surface; a first solar panel pivotally attached to the top surface, the first solar panel is rotatable, and covers the grooves when the first solar panel is closed; at least one second solar panel attached at a side wall of the main body, the second solar panel is embedded in the main body when it is not in use, and will be take out when it is in an operation state.

### BACKGROUND

The present invention relates to solar energy charging devices, and more particularly to a solar energy charging device having foldable solar panels.

Nowadays, the ability for continuously providing power of the electronic products, such as mobile phones, PDA (personal digital assistance), DV (digital video) or the like is more and more important, thus the tourist or the person on business commonly takes a reverse power supply. Generally, the reverse power supply is portable, which has a thin and light figure, and the user may conveniently take the reverse power supply on flight or on vacation in order to charge the electronic products at any time.

The typical charging device includes a lead, and one end of the lead includes a pin to electrically connect to utility power supply, and the other end of the led is electrically connected to a main body of the charging device. In operation, a transformer converts the utility power supply to direct current and transports the direct current to the main body of the charging device via the lead, and then the battery inserted in a charge port of the charging device may be charged. However, when the power is cut off, or in an outdoor environment, the charge device is out of use at all.

An apparatus for charging an electronic device using solar energy is disclosed in Taiwan Patent No. 562,322. The conventional solar energy charging device includes a solar panel, a voltage regulator circuit disposed under and connected to the solar panel, an electric power output mechanism electrically connected to the voltage regulator circuit, and a main body having a plurality of charging ports electrically connecting to the voltage regulator circuit, for containing mobile phones. With this configuration, the solar energy charging device may convent solar energy into electric power for charging mobile phones. The main body of the solar energy charging device includes a locating groove disposed at a side wall thereof, and the locating groove is used for fixing the solar panel to make the solar panel engaging with the main body. Therefore, when use the solar energy charging device to charge a mobile phone, the user has to arrange a solar panel to the main body via the locating groove in advance.

The solar energy charging device above-disclosed may use when the power is cut off, or in an outdoor environment. However, the solar panel is not stability engaged with the main body thereof, even after engaging, the solar panel is liable to become flexible due to frequently scrubbing and plugging, and is liable to impact the electrically connecting between the solar panel and the circuit in the main body.

Accordingly, what is needed is a solar energy charging device that can overcome the above-described deficiencies.

### BRIEF SUMMARY

An exemplary solar energy charging device includes a main body having a plurality of grooves disposed at a top surface thereof for inserting batteries or electronic devices; a plurality of indicator lights disposed at a peripheral portion of the top surface; a first solar panel pivotally attached to the top surface, the first solar panel is rotatable, and covers the grooves when the first solar panel is closed; at least one second solar panel attached at a side wall of the main body, the second solar panel is embedded in the main body when it is not in use, and will be take out when it is in an operation state.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a solar energy charging device according to a first embodiment of the present invention;

FIG. 2 is a schematic view of the solar energy charging device of FIG. 1, showing a mobile phone being engaging to the solar energy charging device;

FIG. 3 is a schematic view of the solar energy charging device of FIG. 2, showing the solar energy charging device in an operation state;

FIG. 4 is schematic, front view of the solar energy charging device of FIG. 1, showing the positions of solar panels thereof;

FIG. 5 is a schematic view of the solar energy charging device of FIG. 1, showing the solar energy charging device having varied solar panels; and

FIG. 6 is a schematic view of a solar energy charging device according to a second embodiment of the present invention, showing which in an operation state.

### DETAILED DESCRIPTION

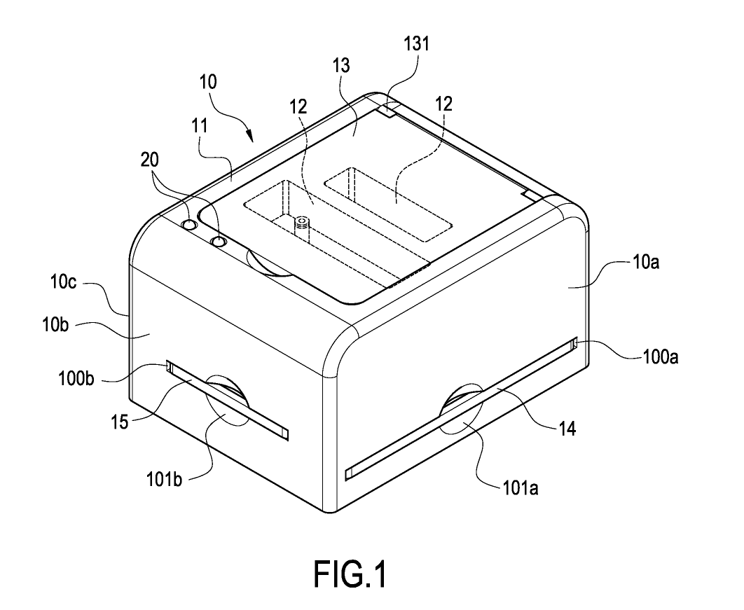

Referring to FIG. 1, a perspective view of a solar energy charging device according to a first embodiment of the present invention is shown. The solar energy charging device includes a main body 10 having an inside space for accommodating printed circuit board, electronic elements, and at least one storage battery. The storage battery is used for storing the electric power that is being converting from solar energy.

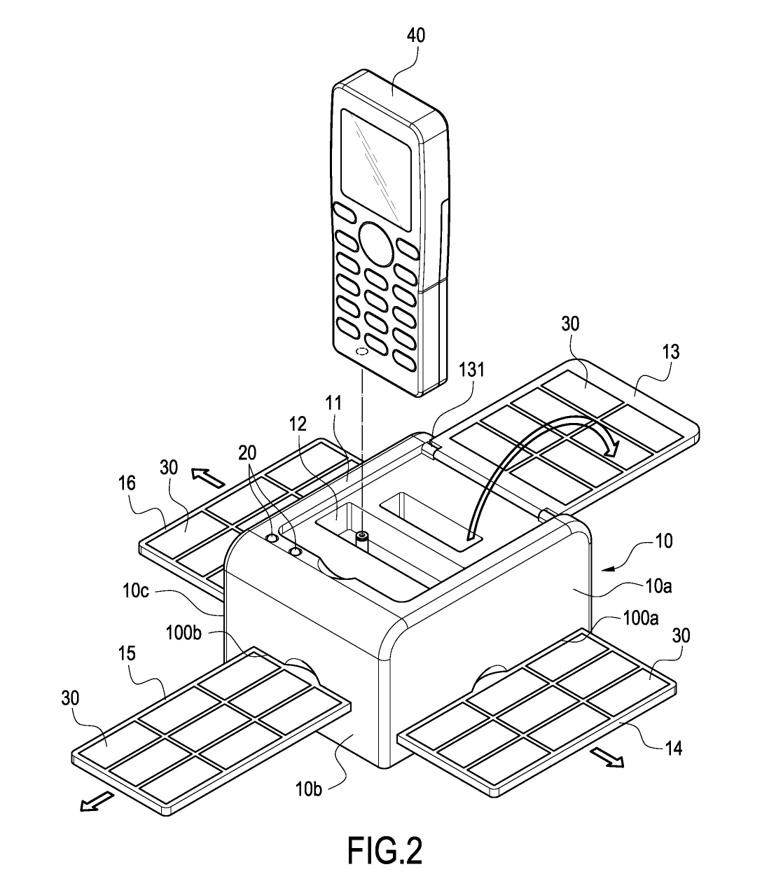

The main body 10 includes a top surface 11 and a plurality of charge grooves 12 disposed under center portion of the top surface 11. The charge grooves 12 includes a plurality of charge ports (not labeled) therein for charging mobile phone, PDA, DV, batteries of the electronic products or the like. The center portion of the top surface 11 is a first solar panel 13, which is pivotally attached to the top surface 11 of the main body 10 via a pivot 131. The first solar panel 13 is rotatable, and covers the charge grooves 12 when the first solar panel 13 is closed. The main body 10 further includes three side walls 10a, 10b and 10c, and each of the side walls 10a, 10b and 10c respectively includes a slot 100a, 100b and 100c thereof. Each of the slots 100a, 100b and 100c respectively includes an opening portion 101a, 101b and 101c, which makes the user to conveniently take out the solar panels (shown in FIG. 2) from the slots 100a, 100b and 100c. The top surface 11 of the main body 10 further includes two indicator lights disposed at a peripheral portion thereof, for indicating the charging state.

Also referring to FIG. 2, the solar energy charging device further includes a second solar panel 14, a third solar panel 15, and a fourth solar panel 16 respectively contained in the slots 100a, 100b and 100c. The second, third, and fourth solar panels 14, 15, and 16 may be taken out from the slots 100a, 100b and 100c.

The top surface of the solar panels 13, 14, 15 and 16 may be made from silicon wafer material, which is used for absorbing and converting solar energy. Then, the silicon wafer material is very important and is needed to be maintained in a high efficiency state. The top surface of the solar panels 13, 14, 15 and 16 are liable to be scraped and aging due to frequently exposure in the environment, which will impact the efficiency of gathering solar light beams. Therefore, the main body 10 of the solar energy charging device defines inner space to contain the solar panels 13, 14, 15 and 16, and the solar panels 13, 14, 15 and 16 may be extended from the main body 10 when they are needed to use.

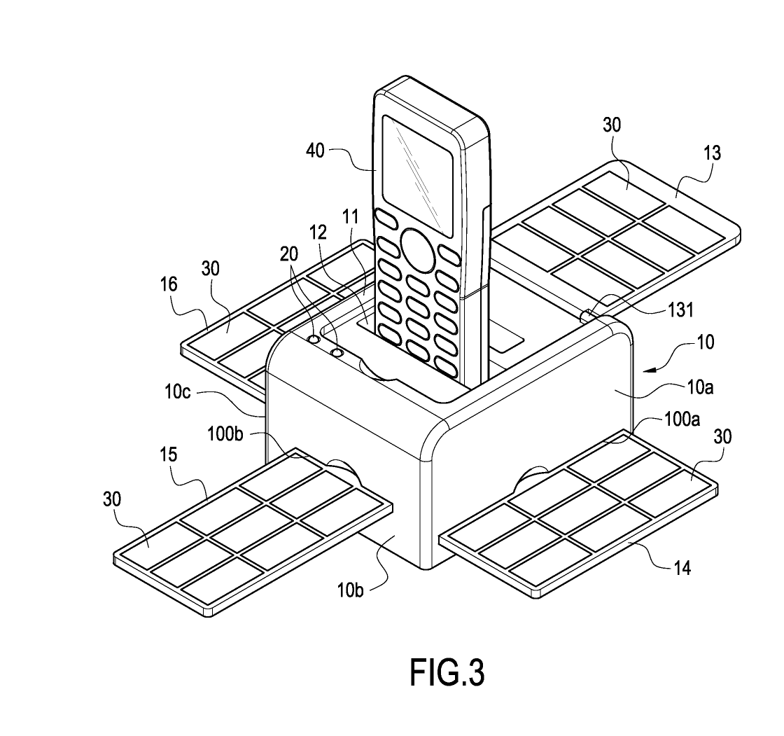

The first solar panel 13 is pivotally attached to the top surface 11 of the main body 10 via a pivot 131, and the first solar panel 13 is rotatable and covers the charge grooves 12. The closed first solar panel 13 may protect the silicon wafer material thereof and the charge grooves 12 when the closed first solar panel 13 does not in an operation state, and prevent the dust from falling into the charge grooves 12. When the power is cut off, or in an outdoor environment, the solar panels 13, 14, 15 and 16 are extended out of the main body 10 to absorb the solar light beams, and convert the solar energy to electric power to charge the mobile phone 40 (shown in FIG. 3) or batteries.

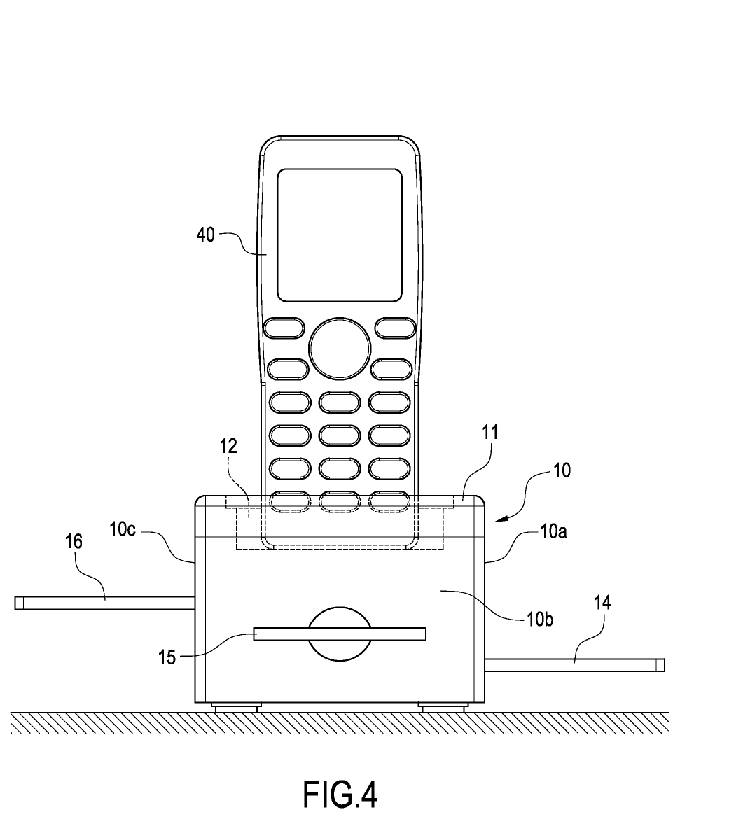

Referring to FIG. 4, the main body 10 has a certain height, which includes an inner space for containing charge ports, solar panels 14, 15 and 16 therein, and the first solar panel 13 is disposed at the center portion of the top surface 11. The positions of all the elements of this solar energy charging device are individual, and will not interfere with each other.

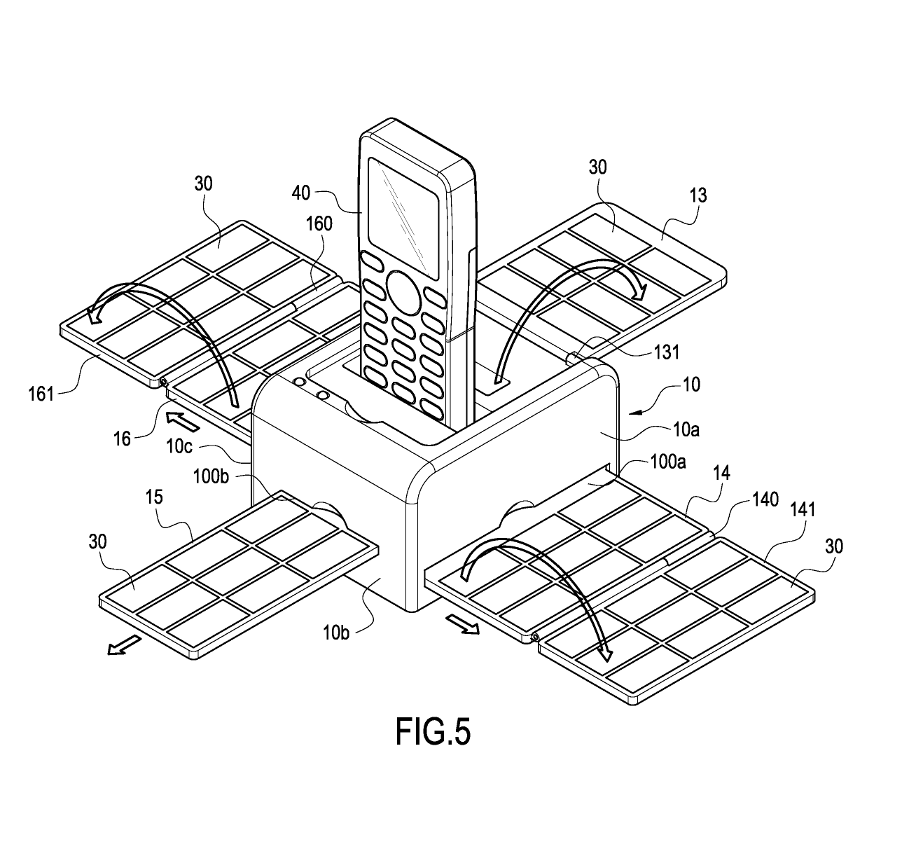

Referring to FIG. 5, a solar energy charging device having varied solar panels is shown. Sub solar panels 141 and 161 are respectively pivotally attached to the second solar panel 14 and the fourth solar panel 16 via a corresponding pivot 140 and 160. The sub solar panels 141 and 161 may increase the area of the silicon wafer material that to absorb solar light beams, which is help to lower the charging time and improve the charging efficiency of the solar energy charging device. The sub solar panels 141 and 161 may rotate around the pivot 140 and 160 to fold and cover the second solar panel 14 and the fourth solar panel 16 respectively. Then the folded sub solar panels 141 and 161 may be contained in the slots 100a and 100c respectively with the second and fourth solar panels 14 and 16. Therefore, the silicon wafer material of the solar panels 14 and 16 and the sub solar panels 141 and 161 may be protected. The folded structure of the solar panels are not limited to above-described embodiments, solar panel having three sub solar panels that pivotally attached together, one of the solar panel having multi sub solar panels that attached together, or the like may all employed in the solar energy charging device.

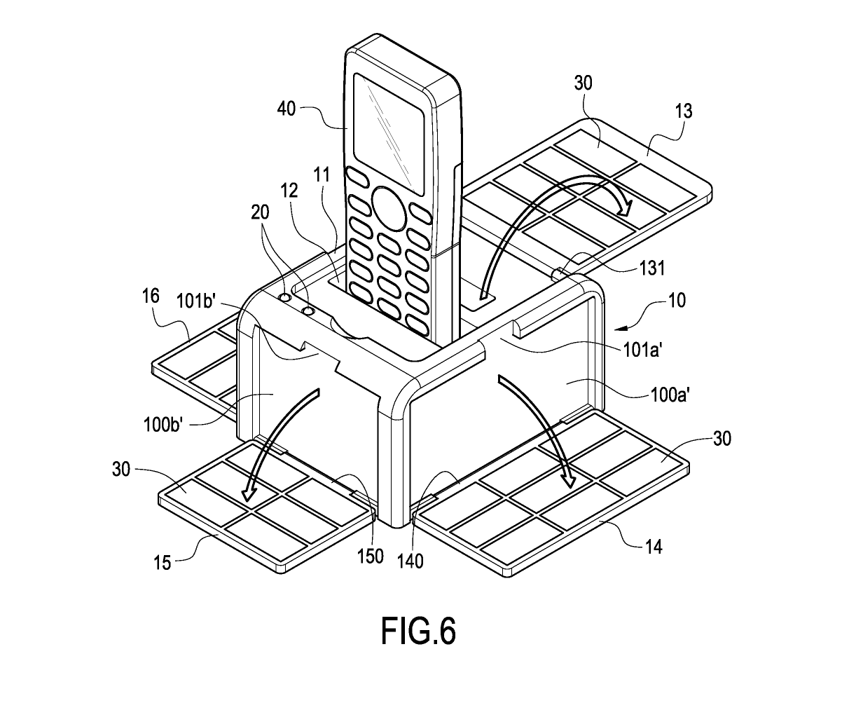

Referring to FIG. 6, a schematic view of a solar energy charging device according to a second embodiment of the present invention is shown. One side view of the solar energy charging device is not shown, but still mentions corresponding numbers of the elements in this embodiment. The solar charging device of the second embodiment has a structure similar to that of the solar charging device of the first embodiment, which includes grooves 100a′, 100b′ and 100c′ disposed at the side walls (not labeled) of the main body (not labeled), which has a plane shaped. Each of the grooves 100a′, 100b′ and 100c′ respectively includes a pivot 140, 150 and 160 and an opening portion 101a′, 101b′ and 101c′ disposed at an edge portion of the grooves 100a′, 100b′ and 100c′. The second, third, and fourth solar panels 14, 15 and 16 are pivotally attached to the main body via the pivots 140, 150 and 160 respectively, which has a shape identical to that of the grooves 100a′, 100b′ and 100c′. The second, third, and fourth solar panels 14, 15 and 16 may contain in the grooves 100a′, 100b40 and 100c′ and may rotate around the pivots 140, 150 and 160 so as to horizontally extend. In operation, the solar panels 14, 15 and 16 may extend via rotating, which prevent the silicon wafer material thereon from exposure in the environment. With these configurations, the efficiency of gathering solar light beams of the solar energy charging device is maintained at a high level.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A solar energy charging device, comprising:
a main body having a predetermined height, the main body comprising an inner space, at least one groove being disposed at a top surface thereof and at least one slot being disposed at a side wall thereof;
a first solar panel pivotally attached to the top surface via a pivot, the first solar panel being rotatable and enable to cover to the at least one groove; and
at least one second solar panel moveably contained in the slot, the at least one second solar panel being embedded in the slot, and extended out from the slot in an operation state.

2. The solar energy charging device as claimed in claim 1, further comprising a plurality of slots disposed at other side walls respectively.

3. The solar energy charging device as claimed in claim 2, further comprising a third solar panel moveably contained in the slot, the third solar being individually disposed and apart from the first solar panel.

4. The solar energy charging device as claimed in claim 3, further comprising a third and a fourth solar panels respectively moveably contained in corresponding slots, the first, second, and third solar panels being individually disposed and apart from each other.

5. The solar energy charging device as claimed in claim 1, further comprising indicator lights disposed at a peripheral portion of the top surface for indicating the charging state.

6. The solar energy charging device as claimed in claim 1, wherein the second solar panel comprises a pivot for pivotally attached a sub solar panel, the sub solar panel is rotatable and is able to fold and cover the second solar panel and contain in the slot with the second solar panel.

7. The solar energy charging device as claimed in claim 2, wherein each of the slots has a plane shape, and each of the slots comprises a pivot and an opening portion disposed at an edge portion of the slots, the solar panel has a shape identical to that of the groove and pivotally attached to corresponding pivot.
